(19) United States
(12) Patent Application Publication
(10) Pub. No.: US 2014/0233628 A1
(43) Pub. Date: Aug. 21, 2014

(54) METHOD OF COMBINING SIGNALS FROM MULTIPLE CHANNELS IN A MULTI-ANTENNA RECEIVER AND ITS APPARATUS

(71) Applicant: SPREADTRUM COMMUNICATIONS (SHANGHAI) CO., LTD., Shanghai (CN)

(72) Inventors: Xuqiang SHEN, Shanghai (CN); Qiang CAO, Shanghai (CN); Xiaojian DONG, Shanghai (CN)

(73) Assignee: SPREADTRUM COMMUNICATIONS (SHANGHAI) CO., LTD., Shanghai (CN)

(21) Appl. No.: 14/182,061

(22) Filed: Feb. 17, 2014

(30) Foreign Application Priority Data
Feb. 18, 2013 (CN) 201310052871.3

(51) Int. Cl. H04B 7/08

(52) U.S. Cl. CPC H04B 7/0857
USPC 375/232

(57) ABSTRACT

The present invention relates to the field of MIMO wireless communication. Disclosed are a method for combining signals from multiple channels in a multi-antenna receiver and its apparatus. In the present invention, weight values corresponding to each antenna are calculated based on noise estimates or SNRs obtained from channel estimation, and a weighted combination is performed on each signal after channel equalization, which can effectively reduce impact of noises on signals and improve performances of receivers. Weight values are calculated for each subcarrier of each antenna based on noise estimates or SNRs, and a weighted combination is performed in subsequent step, which can further improve performances of OFDM receivers for a OFDM system.

### FIELD

The present invention relates to the field of MIMO wireless communication, and more particularly relates to signal combination technology in a multi-antenna receiver.

### BACKGROUND

A multiple-input multiple-output (MIMO) system is a core technology applied to 802.11n. 802.11n is a brand new wireless local area network (LAN) technology following 802.11b\a\g for IEEE, whose rate can be up to 600M bps. Meanwhile, specialized MIMO technology can improve performances of prior 802.11a/b/g network. This technology was first proposed by Marconi in 1908, which utilizes multiple antennas to suppress channel fading. According to antenna number on receiving and sending ends, a MIMO system may further comprise a single-input multiple-output (SIMO) system and a multiple-input single-output (MISO) system relative to an ordinary single-input single-output (SISO) system.

With the development of MIMO technology, its multi-antenna receiving has become main stream now. It is required to combine data received from multiple antennas after multi-antenna receiving, and different combination methods may influence performances of receivers in certain situations.

After multi-antenna receiving, current common way is to directly perform combination straight with the received data, which has little impact on performances of receivers in normal circumstances. However, the combination method of direct combination cannot satisfy practical requirements in particular situations.

### BRIEF SUMMARY

The purpose of the present invention is to provide a method of combining signals from multiple channels in a multi-antenna receiver and its apparatus, which can effectively reduce impact of noises on signals and improve performances of receivers.

To solve the above technical problems, one embodiment of the present invention discloses a method of combining signals from multiple channels in a multi-antenna receiver, which includes the following steps:

respectively performing channel estimation on signals received from N antennas, and obtaining N channel estimation results, N>1;

respectively performing channel equalization on the signals received from N antennas based on the N channel estimation results;

obtaining N noise estimates or SNRs respectively from the N channel estimation results;

calculating N weight values based on the N noise estimates or SNRs, and between(or among) the N weight values, the weight value corresponding to the signal with relatively large noise estimate or relatively low SNR is relatively small;

performing a weighted combination on N signals having undergone the channel equalization based on the N weight values in subsequent processing.

Another embodiment of the present invention also discloses an apparatus of combining signals from multiple channels in a multi-antenna receiver, which comprises:

a channel estimation unit for respectively performing channel estimation on signals received from N antennas and obtaining N channel estimation results, N>1;

a channel equalization unit for respectively performing channel equalization on the signals received from N antennas based on the N channel estimation results output by the channel estimation unit;

a noise estimate/SNR unit for obtaining N noise estimates or SNRs respectively from the N channel estimation results output by the channel estimation unit;

a weight value calculation unit for calculating N weight values based on the N noise estimates or SNRs output by the noise estimate/SNR unit, and between(or among) the N weight values, the weight value corresponding to the signal with relatively large noise estimate or relatively low SNR is relatively small;

a weighted combination unit for performing a weighted combination on N signals having undergone channel equalization which are output by the channel equalization unit based on the N weight values calculated by the weight value calculation unit in subsequent processing.

Comparing the embodiments of the present invention with prior arts, the main differences and their effects are:

Weight values corresponding to each antenna are calculated based on noise estimates or SNRs obtained from channel estimation, and a weighted combination is performed on each signal after channel equalization, which can effectively reduce impact of noises on signals and improve performances of receivers.

Further, weight values are calculated for each subcarrier of each antenna based on noise estimates or SNRs, and a weighted combination is performed in subsequent step, which can further reduce impact of noises on signals and improve performances of OFDM receivers for an OFDM system.

Further, the proportion of each noise estimate in the total noise estimate is subtracted from 1 to determine the weight for a weighted combination, where the amount of calculation is small, but the effect is very significant.

Further, the proportion of each SNR in the total SNR is utilized to determine the weight for a weighted combination, where the amount of calculation is small, but the effect is very significant.

### BRIEF DESCRIPTION OF THE DRAWINGS

FIG. 1 illustrates a flowchart of a method for combining signals from multiple channels in a multi-antenna receiver, according to the first embodiment of the present invention.

FIG. 2 illustrates a schematic diagram of a processing for combining signals from multiple channels in a multi-antenna receiver, according to the second embodiment of the present invention.

FIG. 3 illustrates a block diagram of an apparatus for combining signals from multiple channels in a multi-antenna receiver, according to the fifth embodiment of the present invention.

### DETAILED DESCRIPTION

In the following description, numerous technical details are provided for readers to better understand the application. However, it will be understood by one of ordinary skilled in the art that the technical solution claimed to be protected by those claims of this application can also be realized even without these technical details and not based on various changes and modifications of the following embodiments.

For the purpose, technical solution and merits of this invention to be clearer, the following will further describe the embodiments of the present invention in detail with reference to the drawings.

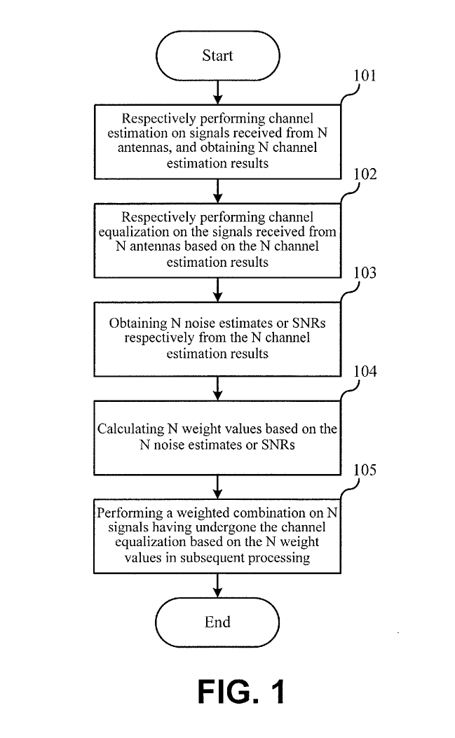

The first embodiment of the present invention relates to a method of combining signals from multiple channels in a multi-antenna receiver. FIG. 1 illustrates a flowchart of a method for combining signals from multiple channels in a multi-antenna receiver.

Specifically, as shown in FIG. 1, the method of combining signals from multiple channels in a multi-antenna receiver includes the following steps:

In step 101, channel estimation is respectively performed on signals received from N antennas, and N channel estimation results are obtained, wherein N>1.

Then proceed to step 102, channel equalization is respectively performed on the signals received from N antennas based on the N channel estimation results.

Then proceed to step 103, N noise estimates or SNRs are obtained respectively from the N channel estimation results.

The noises referred to in embodiments of the present invention may include interferences, or may not include interferences. In the example with interferences included, a noise estimate corresponds to an interference-plus-noise estimate, and a signal-noise ratio(SNR) corresponds to a Signal-to-interference-plus-noise ratio (SINR).

Then proceed to step 104, N weight values are calculated based on the N noise estimates or SNRs, and between(or among) the N weight values, the weight value corresponding to the signal with relatively large noise estimate or relatively low SNR is relatively small.

Additionally, it can be understood that, “between(or among) the N weight values, the weight value corresponding to the signal with relatively large noise estimate or relatively low SNR is relatively small” means “if two weight values are arbitrarily selected from the N weight values, the weight value corresponding to relatively large noise estimate between the two values is relatively small, or the weight value corresponding to relatively low SNR between the two values is relatively small”.

Then proceed to step 105, a weighted combination is performed on N signals having undergone the channel equalization based on the N weight values in subsequent processing.

In the step of performing a weighted combination based on the N weight values in subsequent processing, a weighted combination is performed on the signals or powers output from channel equalization.

Specifically, the subsequent processing is a combination of the equalized data, or the subsequent processing is a soft bit mapping.

Additionally, it can be understood that in some other embodiments of the present invention, except in the equalized data's combination part or the soft bit mapping part, a weighted combination for data from multiple channels can also be performed in other processing part, as long as the processing part is after channel equalization.

Then the flow ends.

Weight values corresponding to each antenna are calculated based on noise estimates or SNRs obtained from channel estimation, and a weighted combination is performed on each signal after channel equalization, which can effectively reduce impact of noises on signals and improve performances of receivers.

The second embodiment of this invention relates to a method of combining signals from multiple channels in a multi-antenna receiver.

The second embodiment improves the first embodiment, and the main improvements are described below.

The multi-antenna receiver is a multi-antenna receiver in an orthogonal frequency division multiplexing (OFDM) system.

Before channel estimation, the method of combining signals from multiple channels in a multi-antenna receiver further includes a step of performing a fast Fourier transform (FFT) on the signals received from N antennas.

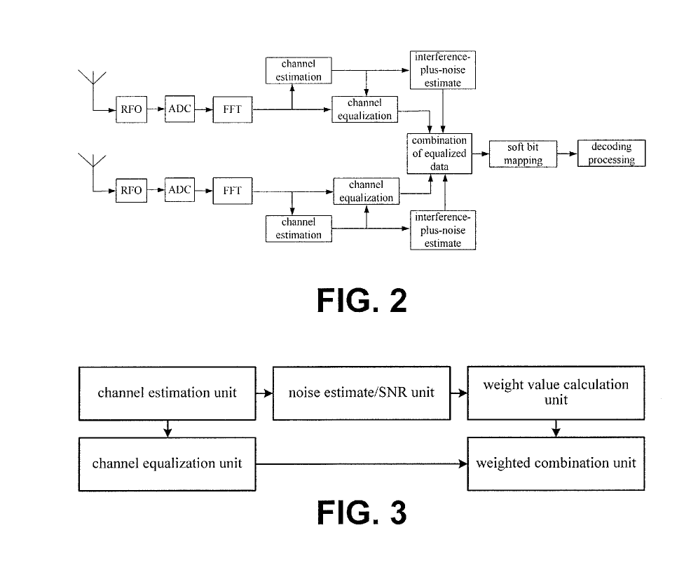

A step of performing an analog-to-digital conversion (ADC) is further included before performing the FFT, as specifically shown in FIG. 2, FIG. 2 illustrates a schematic diagram of a processing for combining signals from multiple channels in the multi-antenna receiver.

Additionally, it can be understood that the present invention's technical solution may also be applied to a communication system performing a FFT, otherwise it may also be similarly processed in accordance with the present invention's technical solution in a time-domain system where processings such as FFT etc. are not required.

In the step of calculating N weight values based on the N noise estimates or SNRs, weight values are respectively calculated for each subcarrier received from each antenna.

In the step of performing a weighted combination based on the N weight values in subsequent processing, a weighted combination is performed on each subcarrier of each antenna based on corresponding weight values.

Weight values are calculated for each subcarrier of each antenna based on noise estimates or SNRs, and a weighted combination is performed in subsequent step, which can further reduce impact of noises on signals and improve performances of OFDM receivers for an OFDM system.

The third embodiment of the present invention relates to a method of combining signals from multiple channels in a multi-antenna receiver.

The third embodiment improves the second embodiment, and the main improvements are described below.

The step of calculating N weight values based on the N noise estimates includes the following substeps:

calculating a sum of the N noise estimates, respectively dividing the sum by the N noise estimates to obtain N quotients, and respectively subtracting the N quotients from 1 to obtain N weight values.

The proportion of each noise estimate in the total noise estimate is subtracted from 1 to determine the weight for a weighted combination, where the amount of calculation is small, but the effect is very significant.

Additionally, it can be understood that in some other embodiments of the present invention, other methods based on noise estimates can also be utilized to calculate the N weight values, and it will produce certain effect as long as the weight value corresponding to the signal with relatively large noise estimate is relatively small between(or among) the N weight values.

The fourth embodiment of the present invention relates to a method of combining signals from multiple channels in a multi-antenna receiver.

The fourth embodiment is basically same with the third embodiment, and the main differences are described below.

The step of calculating N weight values based on the N SNRs includes the following substeps:

calculating a sum of the N SNRs, and respectively dividing the sum by the N SNRs to obtain N weight values.

The proportion of each SNR in the total SNR is utilized to determine the weight for a weighted combination, where the amount of calculation is small, but the effect is very significant.

Additionally, it can be understood that in some other embodiments of the present invention, other methods based on SNRs can also be utilized to calculate the N weight values, and it will produce certain effect as long as the weight value corresponding to the signal with relatively low SNR is relatively small between(or among) the N weight values.

In a preferred example, preferably the multi-antenna receiver has two receiving antennas, specifically, as shown in FIG. 2.

Through interference and noise estimate for each receiving antenna, noise values of the two receiving antennas which are set as Noise, are estimated, or SNRᵢ of the two receiving antennas are estimated, wherein i is an index for the receiving antenna which respectively is 0 or 1.

Two weight values are calculated by:
Rate₀=1−Noise₀/(Noise₀+Noise₁), Rate₁=1−Noise₁/(Noise₀+Noise₁)

or calculated by:
Rate₀=SNR₀/(SNR₀+SNR₁), Rate₁=SNR₁/(SNR₀+SNR₁),

then corresponding weight values are utilized to weight the equalized data, defining the signal output from channel equalization as EqOutᵢ and the power of each antenna after equalization as Powerᵢ.

We modify its two antennas' background noise difference, and perform a combination on the equalized data; and the combined result may be represented by:

EqCombin=EqOut₀*Rate₀+EqOut₁*Rate₁.

Or a weighted combination is directly performed on the equalized power, and the combined result may be represented by:

PowerCombin=Power₀*Rate₀+Power₁*Rate₁.

Then a soft bit mapping and a decoding operation are performed on the combined data.

The method embodiments of the present invention all can be realized by software, hardware and firmware etc. Regardless of the present invention is realized by software, or hardware, or firmware, the instruction codes can be stored in any type of computer accessible memory (such as permanent or can be modified, volatile or non-volatile, solid-state or non solid, fixed or replaceable medium etc.). Similarly, the memory can be, for example, programmable array logic(PAL), random access memory(RAM), programmable read only memory(PROM), read-only memory(ROM), electrically erasable programmable ROM(EEPROM), floppy disc, optical disc, and digital versatile disc(DVD) etc.

The fifth embodiment of the present invention relates to an apparatus of combining signals from multiple channels in a multi-antenna receiver. FIG. 3 illustrates a block diagram of an apparatus for combining signals from multiple channels in a multi-antenna receiver.

Specifically, as shown in FIG. 3, the apparatus of combining signals from multiple channels in a multi-antenna receiver comprises:

a channel estimation unit for respectively performing channel estimation on signals received from N antennas and obtaining N channel estimation results, wherein N>1;

a channel equalization unit for respectively performing channel equalization on the signals received from N antennas based on the N channel estimation results output by the channel estimation unit;

a noise estimate/SNR unit for obtaining N noise estimates or SNRs respectively from the N channel estimation results output by the channel estimation unit;

a weight value calculation unit for calculating N weight values based on the N noise estimates or SNRs output by the noise estimate/SNR unit, and between(or among) the N weight values, the weight value corresponding to the signal with relatively large noise estimate or relatively low SNR is relatively small;

a weighted combination unit for performing a weighted combination on N signals having undergone channel equalization which are output by the channel equalization unit based on the N weight values calculated by the weight value calculation unit in subsequent processing.

The first embodiment is the method embodiment corresponding to this embodiment, and this embodiment and the first embodiment can be implemented in cooperation with each other. Correlated technical details disclosed in the first embodiment are still effective in this embodiment and will not be repeated here in order to reduce duplication. Correspondingly, correlated technical details disclosed in this embodiment can also be applied in the first embodiment.

The sixth embodiment of the present invention relates to an apparatus of combining signals from multiple channels in a multi-antenna receiver.

The sixth embodiment improves the fifth embodiment, and the main improvements are described below.

The multi-antenna receiver is a multi-antenna receiver in an OFDM system.

Additionally, the apparatus of combining signals from multiple channels in a multi-antenna receiver further comprises: a FFT unit for performing a FFT on the signals received from N antennas, and the N signals after the FFT are inputted to the channel estimation unit.

The weight value calculation unit respectively calculates weight values for each subcarrier received from each antenna.

The weighted combination unit performs a weighted combination on each subcarrier of each antenna based on corresponding weight values.

The second embodiment is the method embodiment corresponding to this embodiment, and this embodiment and the second embodiment can be implemented in cooperation with each other. Correlated technical details disclosed in the second embodiment are still effective in this embodiment and will not be repeated here in order to reduce duplication. Correspondingly, correlated technical details disclosed in this embodiment can also be applied in the second embodiment.

The seventh embodiment of the present invention relates to an apparatus of combining signals from multiple channels in a multi-antenna receiver.

The seventh embodiment improves the sixth embodiment, and the main improvements are described below.

The noise estimate/SNR unit calculates N weight values based on the N noise estimates, and the calculation method is:

calculating a sum of the N noise estimates, respectively dividing the sum by the N noise estimates to obtain N quotients, and respectively subtracting the N quotients from 1 to obtain N weight values.

The third embodiment is the method embodiment corresponding to this embodiment, and this embodiment and the third embodiment can be implemented in cooperation with each other. Correlated technical details disclosed in the third embodiment are still effective in this embodiment and will not be repeated here in order to reduce duplication. Correspondingly, correlated technical details disclosed in this embodiment can also be applied in the third embodiment.

The eighth embodiment of the present invention relates to an apparatus of combining signals from multiple channels in a multi-antenna receiver.

The eighth embodiment is basically same with the seventh embodiment, and the main differences are described below.

The noise estimate/SNR unit calculates N weight values based on the N SNRs, and the calculation method is:

calculating a sum of the N SNRs, and respectively dividing the sum by the N SNRs to obtain N weight values.

The fourth embodiment is the method embodiment corresponding to this embodiment, and this embodiment and the fourth embodiment can be implemented in cooperation with each other. Correlated technical details disclosed in the fourth embodiment are still effective in this embodiment and will not be repeated here in order to reduce duplication. Correspondingly, correlated technical details disclosed in this embodiment can also be applied in the fourth embodiment.

It should be noted that units disclosed in each device embodiment of the present invention are logical units, on the physical, a logic unit can be a physical unit, and may be part of a physical unit, or implemented in combination of several physical units, and physical implementing methods for these logic units themselves are not the most important, the combination of the functions achieved by these logic units is the key to solving the technical problem disclosed in the present invention. Furthermore, in order to highlight innovative part of the present invention, the above device embodiments of the present invention do not introduce the units which are not related closely to solving the technical problem disclosed in the present invention, which does not indicate that the above device embodiments do not include other units.

It should be explained that in the Claims and Description of the present invention, relationship terms such as first, second etc are just utilized to distinguish one entity or manipulation from another entity or manipulation, instead of requiring or indicating any practical relation or sequence existing between these entities or manipulations. And, the terms “include”, “comprise” or any other variant indicate to nonexclusive covering, thus the process, method, article or equipment including a series of elements not only includes those elements, but also includes other elements which are not definitely listed, or inherent elements of this process, method, article or equipment. Without more limitations, the element defined by the phrase “include a” does not exclude additional same elements existing in the process, method, article or equipment of this element.

By referring to certain preferred embodiments of the present invention, the present invention has been shown and described. But it should be understood to those skilled in the art that various other changes in the forms and details may be made without departing from the principles and scope of the invention.

What is claimed is:

1. A method of combining signals from multiple channels in a multi-antenna receiver, wherein the method includes the following steps:
respectively performing channel estimation on signals received from N antennas, and obtaining N channel estimation results, N>1;
respectively performing channel equalization on the signals received from N antennas based on the N channel estimation results;
obtaining N noise estimates or SNRs respectively from the N channel estimation results;
calculating N weight values based on the N noise estimates or SNRs, and between(or among) the N weight values, the weight value corresponding to the signal with relatively large noise estimate or relatively low SNR is relatively small;
performing a weighted combination on N signals having undergone the channel equalization based on the N weight values in subsequent processing.

2. The method of combining signals from multiple channels in a multi-antenna receiver according to claim 1, wherein the multi-antenna receiver is a multi-antenna receiver in an OFDM system;
before channel estimation, the method further includes a step of performing a fast Fourier transform (FFT) on the signals received from N antennas;
in the step of calculating N weight values based on the N noise estimates or SNRs, weight values are respectively calculated for each subcarrier received from each antenna;
in the step of performing a weighted combination based on the N weight values in subsequent processing, a weighted combination is performed on each subcarrier of each antenna based on corresponding weight values.

3. The method of combining signals from multiple channels in a multi-antenna receiver according to claim 1, wherein the step of calculating N weight values based on the N noise estimates includes the following substeps:
calculating a sum of the N noise estimates, respectively dividing the sum by the N noise estimates to obtain N quotients, and respectively subtracting the N quotients from 1 to obtain N weight values.

4. The method of combining signals from multiple channels in a multi-antenna receiver according to claim 1, wherein the step of calculating N weight values based on the N SNRs includes the following substeps:
calculating a sum of the N SNRs, and respectively dividing the sum by the N SNRs to obtain N weight values.

5. The method of combining signals from multiple channels in a multi-antenna receiver according to claim 1, wherein in the step of performing a weighted combination based on the N weight values in subsequent processing, the weighted combination is performed on signals or powers output from channel equalization.

6. The method of combining signals from multiple channels in a multi-antenna receiver according to claim 1, wherein the subsequent processing is a combination of equalized data, or the subsequent processing is a soft bit mapping.

7. An apparatus of combining signals from multiple channels in a multi-antenna receiver, wherein the apparatus comprises:
a channel estimation unit for respectively performing channel estimation on signals received from N antennas and obtaining N channel estimation results, N>1;
a channel equalization unit for respectively performing channel equalization on the signals received from N antennas based on the N channel estimation results output by the channel estimation unit;
a noise estimate/SNR unit for obtaining N noise estimates or SNRs respectively from the N channel estimation results output by the channel estimation unit;
a weight value calculation unit for calculating N weight values based on the N noise estimates or SNRs output by the noise estimate/SNR unit, and between(or among) the N weight values, the weight value corresponding to the signal with relatively large noise estimate or relatively low SNR is relatively small;
a weighted combination unit for performing a weighted combination on N signals having undergone channel equalization which are output by the channel equalization unit based on the N weight values calculated by the weight value calculation unit in subsequent processing.

8. The apparatus of combining signals from multiple channels in a multi-antenna receiver according to claim 7, wherein the multi-antenna receiver is a multi-antenna receiver in an OFDM system;
the apparatus further comprises a FFT unit for performing a fast Fourier transform on the signals received from N antennas, and the N signals after the fast Fourier transform are inputted to the channel estimation unit;
the weight value calculation unit respectively calculates weight values for each subcarrier received from each antenna;
the weighted combination unit performs a weighted combination on each subcarrier of each antenna based on corresponding weight values.

9. The apparatus of combining signals from multiple channels in a multi-antenna receiver according to claim 7, wherein the noise estimate/SNR unit calculates N weight values based on the N noise estimates, and the calculation method is:
calculating a sum of the N noise estimates, respectively dividing the sum by the N noise estimates to obtain N quotients, and respectively subtracting the N quotients from 1 to obtain N weight values.

10. The apparatus of combining signals from multiple channels in a multi-antenna receiver according to claim 7, wherein the noise estimate/SNR unit calculates N weight values based on the N SNRs, and the calculation method is:
calculating a sum of the N SNRs, and respectively dividing the sum by the N SNRs to obtain N weight values.
